(19) United States
(12) Patent Application Publication
(10) Pub. No.: US 2013/0248430 A1
(43) Pub. Date: Sep. 26, 2013

(54) EXPANDED BED CHROMATOGRAPHIC SEPARATION COLUMN FOR BIOCHEMICAL SEPARATION PROCESS AND TECHNICAL PROCESS THEREOF

(71) Applicant: Xiongyi Gu, Shanghai (CN)

(72) Inventor: Xiongyi Gu, Shanghai (CN)

(73) Assignee: SHANGHAI ZHIXIAN INVESTMENT MANAGEMENT CO., LTD., Shanghai (CN)

(21) Appl. No.: 13/990,177

(22) PCT Filed: Nov. 30, 2011
(86) PCT No.: PCT/CN2011/083219

§ 371 Date: May 29, 2013

(30) Foreign Application Priority Data
Nov. 30, 2010 (CN) 201010565313.3
Nov. 28, 2011 (CN) 201120482321.1

(51) Int. Cl. B01D 15/20

(52) U.S. Cl. CPC B01D 15/203
USPC 210/195.1; 210/198.2; 239/548

(57) ABSTRACT

An expanded bed chromatographic adsorption (EBA) column for a biochemical separation process comprises a pressure equalization liquid distributor having a self-cleaning function below a porous blocking sieve plate at the bottom of the expanded bed, an upper part nozzle assembly having a backflush cleaning function at the top of the expanded bed, a better distribution of the feedstock liquor added into the expanded bed ensuring that the fluid passed through the expanded bed layer displays a state of piston flow. The expanded bed layer displays a state of piston flow. The expanded bed chromatographic separation column has advantages of increasing the separation efficiency of the expanded bed.

### FIELD OF THE INVENTION

The invention belongs to the biochemical field. It relates to a chromatography apparatus and a manufacturing technique used for extraction/separation/purification in bioprocessing and biopharmaceutical industry.

### BACKGROUND OF THE INVENTION

Chromatography is one of the most commonly used purification technology in bioprocessing and biopharmaceutical industry.

Traditional chromatography uses fixed packed bed. The media which can adsorb the target molecules are tightly compressed between the bed support meshes.

Fixed bed has the advantage of even flow distribution across the radius similar to so called plug flow resulted from the higher flow resistance and low void space. All the traditional chromatography purification technology uses fixed bed for packing the chromatography media.

In large scale production in bioprocessing and biopharmaceutical industry it is common that the feedstocks contain particles or cells or cell debris such as in cell lyses from microbial fermentation or cell cultures. Such feed can not be directly applied to fixed bed adsorption because the particles or cells or cell debris would clog the column and make the traditional chromatography impossible to perform.

The common practice is to use centrifugation followed by depth filtration to remove the particles or cells first before it goes to the chromatography step.

The traditional or current art of processing particle or cell containing feed for active product requires quite some steps, long processing time, and high capital expenses. Continuous high-capacity centrifuges are extremely costly and depth filtration has high running cost as well.

The concept of expanded bed adsorption (EBA) was first developed in early 80s.

Instead of packing media tightly in a fixed bed, the media are allowed to suspend with the flow as if a fixed bed gets expanded. The flow usually comes from the bottom of the column and flows upwards to keep the media particles suspended (FIG. 1a).

The void space in an expanded bed is much higher than in a fixed bed and the media particles are constantly moving, therefore particles, cells, or cell debris will be able to flow through the bed while the target molecules can still be captured by the functional groups on the media particles. The obvious advantage of EBA is its ability of processing particle or cell containing feed directly. The idea was to replace the centrifugation and depth filtration and the first chromatography step i.e. the capture step (usually using adsorption) in traditional processes with a single EBA step. This will reduce the process steps and shorten the process time and consequently minimize the production cost.

Although there have been a few cases where EBA was successfully developed to the production scale, EBA technology has not been popular at all. It has seen its applications in bioprocessing industry for E. coli cell lyses, yeast, hybridoma cells, and animal cell cultures for target molecule purification.

However, a potential problem with EBA was the clogging of the bottom distributor because it usually consists at least a mesh. The clogging was caused by the accumulation of the particles in the feed on the mesh. The cleaning issue with both the bottom mesh and top mesh has been a major problem with developing EBA application.

Occasionally, EBA bed may get unstable and clogging happens at the top mesh as well when the feed tends to aggravate by itself or with the media.

The other disadvantage with EBA was the low plate count of the bed caused by less ideal flow distribution across the radius.

This is mostly resulted from nearly no flow resistance from the bed. In other words the flow going through the bed is far from ideal plug flow and this causes low efficiency of adsorption. The flow pattern in an EBA bed was illustrated in FIG. 1b. As the distributor was not able to create equal pressure or even flow before the flow going into the mesh and the bed, there were server back mixing happening at the lower part of the expanded bed. This leads to significant decrease of the plate count in the EBA bed (about 50).

Plate count is a measurement of the deviation of the actual flow pattern in a flow system away from ideal plug flow based on the concept of residence time. Most of the chromatography processes need to have certain number of plate count for the process to be effective.

An ideal plug flow will have infinitive number of plate count while a complete mixing stage will have a count of one.

Both theoretical estimation and empirical data suggested that the performance of adsorption chromatography would be hardly effected when the total plate count in a column is bigger than 400 (in practice most of the chromatography columns have total plate count greater than 3000). The idea of EBA was to introduce the ability for processing particle containing feed directly and increasing the throughput of processing at the same time, at the cost of reducing the unnecessarily high total plate count in the column. As the expanded bed has limited pressure resistance, it was a challenge and of critical importance to design a flow distributor that can even out the pressure along the radius before feed going into the bed and allow plug flow going into the bed.

There are relatively few publications regarding distributor design in EBA columns.

Amersham Biosciences (now part of GE) and Upfront made some important efforts in addressing these issues by using distributing arms periodically oscillating in an EBA bed (nicknamed as spider). Another effort was to apply sweeping flow across the mesh to avoid the particle accumulation as shown in US2007199899A1.

The spider idea was illustrated in FIG. 2a. Feed is coming from the inlet and led to the perforated distribution arms where the feed is being injected towards the column bottom while the arms are oscillating. There possibly several arms on the oscillating spider.

The distributor is fully cleanable. The problems are the flow distribution and possible mechanical grinding of the media. At the bottom of the EBA bed where the spider oscillates the flow is far from ideal plug. The total plate count of EBA column with spider is rather low. This has caused performance deterioration. The main advantage of using chromatography is therefore being lost. The other disadvantage of spider design is that the EBA column will have to include moving parts which causes additional sealing challenge. The mechanical grinding of the media particles is also fatal to the process. As a result, spider design has never got any industrial application in production scale despite the commercial products available from GE and Upfront.

The tangential sweeping concept was seen in US2007199899A1 (FIG. 2b). Feed is delivered by pump 110 and the flow is regulated by 120. The feed flow will go from one side of the column to the other side of the column. The feed flow, driven by pump 140 will go into the EBA bed while sweeping (125) underneath the bed support mesh and coming out from the other side for recirculation.

The idea of sweeping from one side of the column to the other side of the column will somehow address the self cleaning issue. However there are obvious problems. This design takes no consideration of flow distribution in the EBA bed.

1. Flow distribution across the mesh will be uneven from the inlet side to the outlet side. Flow distribution across the mesh will be uneven or different on the two sides that are perpendicular to the line from inlet to outlet. To even out the flow across the mesh it is desired to have larger volume underneath the mesh, however this will cause problems in cleaning the distributor and the mesh, and undesired back-mixing which will reduce the total plate count.

2. As the feed concentration gets higher and higher during the loading, aggregation tends to happen and clogging is still difficult to avoid.

So far there has been no commercial application of this idea and no commercial EBA product has been developed based on the design idea either.

### SUMMARY OF THE INVENTION

The purpose of the invention is to provide an expanded bed chromatographic separation column for biochemical separation process and technical process thereof. This invention takes advantage of the column for purifying active target molecules directly from particle obtaining feedstocks. By implementing a specially designed distributor in the bottom adaptor and a back-flush capable bypass valve in the top adaptor, the column is capable of generating even flow across the radius through the expanded bed and is completely self-cleanable when applying to particle containing feed stock, thus meeting the challenge of even flow distribution with low pressure drop in the industry. As a result the separation efficiency and column loading/elution performance can be significantly improved. The Process so designed will also allow in-place transfer of EBA media from slurry tank to the column and vice versa.

The invention provides a column for expanded bed adsorption (EBA) chromatography for biopharmaceutical purification and bioprocessing, comprising a first mesh and an outlet on the top adaptor, and a second mesh and an inlet on the bottom adaptor, characterized by:

the top adaptor includes a bypass valve that allows back flush of the mesh, a feed outlet, a waste outlet, a movable plug, and sealing o-rings;

The bottom adaptor includes a self cleanable even flow distributor, which is comprised of a feed inlet, radial injection holes, a distribution inner core, and a feed outlet;
when aggregation or clogging is happening underneath the top mesh and flow resistance increases, a back flush flow can be applied from above the top mesh through the feed outlet to push the aggregates or clogging away from the mesh, in the meantime the plug is moved down and opens the bypass valve, which allows the aggregates or clogging to be pushed out to the waste, after the back flush, the plug moves up and closes the bypass valve and the normal operation resumes;
Said distribution inner core and the first mesh on the bottom adaptor form the flow distribution channels from the center out along the radial directions;
the feed is injected into the distribution channels in the radial directions by the nozzle, sweeping underneath the mesh and push possible aggregates back to the bulk flow, and goes back to the feed recirculation tank through the outlet, the flow path including the mesh can therefore be self-cleanable by flow itself; and

by implementing the top adaptor with a bypass for back flush and a self cleanable even flow distributor such EBA columns are well fitted to directly process particulate containing feed stocks with improved efficiency and performance in large scale production in biopharmaceutical and bioprocessing industries.

Specifically, the top outlet and the waste outlet are placed above the top mesh and on the top support plate. The waste outlet is passing through the top mesh in the center. The movable plug, sealing o-rings, and part of the waste outlet constitute the bypass valve.

When the plug moves up the plug and the seal o-rings close the waste outlet. The top adaptor works in a normal operation and the feed solution in the bed will pass the top mesh and go out from the top outlet; when the plug moves down, the bypass valve is open and the adaptor can be used for back-flushing. A back flush flow from above the top mesh can be applied to clean the aggregates and clogging underneath it and pushes them out through the top waste outlet.

The Process so designed will also allow in-place transfer of EBA media from slurry tank to the column and vice versa.

The bottom outlet is placed on the bottom support plate.

Specifically, the bottom inlet connects to an injection nozzle with radial holes, placed in the center, right underneath the bottom mesh in the bottom adaptor.

Alternatively, the injection nozzle with evenly aligned radial holes can be made retractable.

The inner distribution core is placed in between the bottom mesh and the bottom support plate. There is an opening in the center of the inner distribution core to allow the inlet/injection nozzle to go through; the space between the bottom mesh and the inner distribution core, the space between the bottom support plate and the inner distribution core, forms the distribution channels and the returning channels.

The distributor is so designed that it is able to provide even flow across the radius through the EBA bed (with only small holdup volume and low flow resistance from the bed) therefore providing EBA bed with plug-like flow and much more total plate count, therefore improved column efficiency and performance.

The entire flow paths in the distributor are completely cleanable by flow itself.

The inner distribution core can be so designed that the height of the injection channel (from the center out to the circumference) can be gradually changing to improve flow distribution and channel cleanability.

The inner distribution core has baffles evenly aligned along the radial directions, both the top side and the down side, to form the distribution channels and the returning channels; the inner distribution core can optionally be made so that there are open spaces between the injection nozzle and the inner distribution core, which serves an important feature of evening further the pressure as the open space will allow additional internal recirculation inside the adaptor.

The inner distribution core is one of the approaches to provide the desired flow/pressure distribution across the radius. A second approach is to use an alternative high and low surface on the bottom support plate.

A second approach of achieving even flow distribution is described in the following paragraphs:

The flow distribution and returning channels are part of the bottom support plate. There are a series of high surfaces (sectors) and low surfaces (sectors) alternated from each other, evenly aligned in radial directions on the bottom support plate. The space between the high surfaces and the bottom mesh forms the flow distribution channels and that between the low surfaces and the bottom mesh forms the flow returning channels. Both the high surfaces and low surfaces are in the shape of sectors. The nozzle is placed in the center.

The space between the high surfaces and the bottom mesh forms the flow distribution channels and that between the low surfaces and the bottom mesh forms the flow returning channels.

The total area of the high surfaces should be larger than the total surfaces of the low surfaces.

This approach is called “horizontal flow returning”.

Specifically, the high surfaces and the low surfaces can be part of the bottom support plate.

The number of the holes on the injection nozzle should be the same as the number of the high surfaces, each hole correspondingly pointing to one of the high surfaces.

A retractable nozzle can be optionally included. The number of the holes on the nozzle however will have to be the same as the number of the high surfaces.

There are three specific forms of the distribution channels in the “horizontal flow returning” design:

1. The distance between the mesh and the high surfaces gradually decreases from the center out to the circumference (as in the flow direction) and the distance between the mesh and the low surfaces gradually increases from the circumference to the center (as in the flow direction)

2. The distance between the mesh and the high surfaces gradually increases from the center out to the circumference (as in the flow direction) and the distance between the mesh and the low surfaces gradually increases from the circumference to the center (as in the flow direction).

3. The distance between the mesh and the high surfaces remains unchanged from the center out to the circumference (as in the flow direction).

A retractable nozzle piece can optionally be included.

When the nozzle piece is up the holes are open and the flow will inject into the distribution channels i.e. the space between the mesh and the high surfaces.

When the nozzle piece is down the holes are closed. This can be useful during elution to eliminate the dead spaces inside the distributor if a downward flow is applied.

An EBA column so designed comprises a column tube, a top adaptor with a bypass valve, top outlet and top waste outlet, and a bottom adaptor with inlet and outlet. The top adaptor can optionally be movable along the column tube.

The EBA chromatography process includes an EBA column of such design, a recirculation tank for the equilibration buffer, a recirculation tank for the feed, a main pump, media storage tank with internal cyclone, packing buffer recirculation tank, in-line filters, and packing pump.

The buffer recirculation tank connects to the feed pump inlet. The pump outlet is connected to the bottom inlet (on the bottom adaptor) of the EBA column. The top outlet (on the top adaptor) of the EBA column is connected to a pressure control valve which is then connected to the product tank or a flow-through holding tank.

The bottom outlet (on the bottom adaptor) of the column is connected to another pressure control valve which is connected back to the buffer recirculation tank. In-line filter may be optionally placed in between the pressure control valve and the recirculation tank.

The bottom outlet (on the bottom adaptor) is connected to the top outlet (on the top adaptor) through a valve to form a bypass line.

The top outlet (on the top adaptor) is connected to the outlet of the feed pump through a valve.

The top waste outlet (on the top adaptor) is vented to waste. The top waste outlet (on the top adaptor) is also connected through a valve to the media tank. The overflow outlet of the media tank is connected to the packing buffer tank which is connected to the inlet of the feed pump.

The inlet of the packing pump is connected to the bottom outlet of the media tank. The outlet of the packing pump is connected to the top waste outlet (on the top adaptor).

The bottom outlet (on the bottom adaptor) has a vent to waste through a valve. The bottom inlet (on the bottom adaptor) has a vent to waste through a valve. The top waste outlet (on the top adaptor) has a vent to waste through a valve as well.

Valves are placed at the bottom inlet and outlet (on the bottom adaptor) and top outlet (on the top adaptor), the inlets and outlets of the buffer recirculation tank, the feed recirculation tank, and the media tank. A flow meter, a pressure transmitter, and conductivity meter are placed in line at the bottom inlet. Another flow meter, another conductivity meter, pH meter, and UV detector are placed in line at the top outlet. Pressure transmitters are also placed in line in buffer recirculation loop and feed recirculation loop.

During operation the feed pump takes the feed from the feed recirculation tank and feed it into the bottom adaptor. Part of the feed is passing through the EBA bed where the active target is being adsorped and the particles and non-active molecules are flowing through. The rest of the feed recirculates back to the feed recirculation tank through the bottom outlet (on the bottom adaptor) when the recirculation is on.

When there are clogging underneath the top mesh a flush can be applied by opening the bypass valve (plug moving up) on the top adaptor and a buffer flow can be pumped through the bypass line to the top outlet (on the top adaptor). The flow will come down from the top and flush out the aggregates/clogging underneath the top mesh into the opened bypass valve and into the waste.

The normal operations for EBA chromatography can be resumed by closing the bypass valve (plug moving down) and restoring the original flow paths when the back flush is done.

The top waste outlet (on the top adaptor) combined with the packing buffer tank, media tank, feed pump, and packing pump can also be used for packing media into the EBA column or unpacking the media out to the media tank, i.e. to move the media from the media tank to the EBA column or vice versa.

Feed, equilibration buffer, and cleaning solution can be continuously added to the feed recirculation tank by controlling constant volume in the feed recirculation tank.

Fresh buffer can be continuously added from the buffer tank to the buffer recirculation tank by controlling constant volume in the buffer recirculation tank.

The inlet of feed pump is connected to the elution buffer tank.

A bubble trap may be placed in-line before the inlet of the bottom adaptor.

The process includes the following steps: equilibration of the EBA bed, feed loading, washing, elution, cleaning/regeneration, and re-equilibration and additionally the packing and unpacking of the media.

### A. Equilibration

Equilibration buffer will first be pumped by the feed pump from the buffer recirculation tank to the bottom inlet on the bottom adaptor, which will come out from both the bottom outlet on the bottom adaptor and the top outlet on the top adaptor. The initial portion of the buffer may be diverted to the waste before switching it to the buffer recirculation tank.

Use the pressure control valve (PCV) at the bottom outlet, the pressure control valve at the top outlet, and the two flow meters at bottom outlet and the top outlet to adjust appropriate flow rates for the recirculation and the flow passing through the EBA column.

After both flow rates are stabilized, wait for a certain amount of time or column volume of equilibration buffer passing through the EBA bed. Optionally monitoring instruments such as conductivity meter can also be used to determine when the equilibration is completed.

### B. Loading

The inlet of the feed pump will first be switched to the feed recirculation tank. The bottom outlet on the bottom adaptor will then be switched to the feed recirculation tank. Adjust both the column flow rate and the recirculation flow back to the target as necessary by working on the PCVs and flow meters.

Part of the feed flow is going through the EBA bed at the column flow rate and the target molecules in the flow are being adorpted to the media particles while other particles or cells passing through the bed. The flow will then go out of the column from the top outlet, through the monitoring instruments, UV, conductivity meter, pressure transmitter, flow meter, and to a flow-through holding tank or waste.

Fresh feed is added to the feed recirculation tank by controlling the constant volume inside the feed recirculation tank.

A back flush on the top mesh may be performed as needed when there is aggregation inside the column or pressure increases. To run the back flush, stop the feed pump and open the bypass valve on the top adaptor. The inlet of the feed pump is switched to the buffer recirculation tank. After pumping some initial portion of the buffer to waste, the feed pump delivers the buffer through the column shortcut line into the top outlet of the top adaptor, which flushes the aggregates or clogging underneath the top mesh away and out into the bypass valve to waste.

After the back flush is completed, stop the pump and close the bypass valve on the top mesh. Switch the inlet of the feed pump to feed recirculation tank and outlet to the bottom inlet on the bottom adaptor and resume the feed loading.

### C. Washing

Switch the inlet of the feed pump to the buffer recirculation tank and the bottom outlet on the bottom adaptor to the buffer recirculation tank. Adjust the recirculation flow and column flow to set points. Wait until a certain amount of buffer has passed through or the monitoring instrument such as conductivity, pH, or UV reaches pre-determined criteria.

### D. Elution

Stop the feed pump and let the bed settle. While keeping the top outlet open to waste, lower the top adaptor until it is close enough to the sediment surface. Lock the adaptor at the position.

Start the feed pump with the pump inlet connected to buffer recirculation tank. Close the bottom outlet (on the bottom adaptor). Adjust the PCVs so that the column flow will be on target. Wait for a certain amount of column volume of buffer passing through or until the monitoring instrument such as conductivity, pH, or UV reaches pre-determined criteria.

To start the elution, the inlet of the feed pump is switched to elution buffer tank. Keep the bottom outlet closed. Adjust the PCVs so that the column flow is on target as the process requires.

Keep monitoring UV, pH, and conductivity, switch the top outlet to the product tank when product peak is detected. Switch the top outlet to flow through holding tank or waste after the peak has passed.

### E. Cleaning/Regeneration

After the elution is done stop the feed pump and open the bypass and the top vent on the top adaptor.

Raise the top adaptor back to its original position, close the bypass valve and lock the position.

Empty the feed recirculation tank and replace it with the cleaning solution from the tank of cleaning solution. Start the feed pump with the inlet of the pump connected to the feed recirculation tank and the bottom outlet on the bottom adaptor connected to the feed recirculation tank as well.

Adjust the recirculation flow and column flow as the process requires. Wait for a certain amount of column volume of cleaning solution passing through or until the monitoring instrument such as conductivity, pH, or UV reaches pre-determined criteria.

### F. Re-Equilibration

After cleaning is finished, stop the feed pump and replace the solutions in the feed recirculation tank with the equilibration buffer.

Start to run the feed pump with both the inlet of the pump and the bottom outlet on the bottom adaptor connected to the feed recirculation tank. The bottom outlet can be briefly diverted to waste.

Adjust the recirculation flow and column flow as the process requires.

Wait for a certain amount of column volume of equilibration buffer passing through or until the monitoring instrument such as conductivity, pH, or UV reaches some criteria.

At the end of regeneration, stop the feed pump and empty the two recirculation tanks (if there is no more run).

### G. Packing

Additionally packing and unpacking of the media into the column can be performed using the same equipment.

Fill the EBA column with packing buffer. Open the bypass valve on the top adaptor.

Start the packing pump to deliver the media slurry into the EBA column through the bypass valve while keeping the top outlet open.

The media particles will settle down inside the column and the packing buffer will overflow from the top mesh on the top adaptor out to waste. EBA column be packed in place thereby.

### H. Unpacking

To unpack the column, close the top outlet on the top adaptor, and open the bypass valve on the top adaptor.

Switch the inlet of the feed pump to packing buffer tank.

Start the feed pump and increase the flow rate until the superficial velocity inside the column exceeds the terminal velocity of the media particles. The media particles will therefore be brought out through the bypass valve back into media slurry tank.

The cyclone inside the media tank will keep the media particles inside the tank but allow the packing buffer to overflow back to the packing buffer tank.

Keep running the feed pump at the flow rate until all media particles move back to the slurry tank.

More specifically fresh buffer can be added to feed recirculation tank to reduce the viscosity and particle concentration and possibly improve the process yield after the feed solution has all been processed.

More specifically the ratio of recirculation flow to column flow can vary from 0 to 10 depending on specific process with regards to flow distribution and cleanability.

During elution phase of the process, when a retractable injection nozzle is used, the nozzle will be retracted to its closing position to avoid any possible dead space in the distribution channels and the returning channels.

### Advantages

1. The EBA column is suitable for directly processing particle containing feed as a result of implementing a self-cleanable even flow distributor underneath the bottom mesh in the bottom adaptor and a back-flush capable bypass valve in the top adaptor.

2. Even flow distribution in EBA column is achieved by implementing a radial injection nozzle placed in the center and the radial distribution-channels and returning-channels shaped by an inner distribution core with bottom mesh and bottom support plate. Thereby constant pressure across the radius can be generated underneath the bottom mesh and plug flow can be achieved in the EBA bed. The higher the flow velocity is the better the plug flow is.

3. The distribution channels are designed with gradually reduced height from the center out to the circumference by the changing shape of the inner distribution core and the baffle height on it. This helps generate the constant pressure under the bottom mesh and minimize the holdup space in the bottom adaptor and therefore total plate count and column efficiency can be greatly improved.

4. The bottom inlet and outlet in the bottom adaptor allow recirculation between a tank and the column distributor when working with a pump. The recirculation flow rate can be an operation parameter to reach the desired even flow distribution in the EBA column

5. The flow channel sizes and the mesh pore size are determined as part of the equipment parameters but recirculation flow and column flow are part of operation parameters of the process. These additional operation parameters make the process easy to control and well fitted to industrial operation. The distributor so designed can achieve even flow distribution with very small holdup volume (in comparison with the bed volume) in the distributor, little back-mixing, very low flow resistance from the bed, and is completely flow-cleanable. These features make it possible to run EBA for processing particle containing feed, at sufficiently high total plate count and low bed expansion, and therefore achieve the core benefit of the original EBA concept

6. Internal recirculation through the interval between the inner distribution core and the injection nozzle helps further with even flow distribution

7. The process enables packing and unpacking in place of the EBA media by using the bypass valve in the top adaptor, therefore is also well fitted to large scale industrial operation

8. Two approaches of achieving plug flow distribution and cleanability are identified: inner distribution core vs. alternative high and low surfaces on bottom support plate, which may find their best applications in large production scale and small lab scale respectively.

9. An optional retractable injection nozzle leads to complete hygienic design. All flow paths are cleanable and there is no dead space.

### BRIEF DESCRIPTION OF THE DRAWINGS

FIG. 1a Traditional expanded bed adsorption (EBA)

FIG. 1b Flow distribution inside a traditional EBA

FIG. 2a EBA design with spider distributor

FIG. 2b EBA design with sweeping flow under the mesh

FIG. 3a Bypass valve during normal operation

FIG. 3b Bypass valve during back flushing

FIG. 4a Bottom adaptor and flow paths inside

FIG. 4b Top view of the inner distribution core and flow paths

FIG. 5 Flow distribution inside the EBA by the invention

FIG. 6 Flow diagram of a chromatography process using EBA

FIG. 7 Functional illustration of the EBA chromatography process

FIG. 8 Flow paths at different stages in the EBA chromatography process

FIG. 9 Packing and unpacking of the EBA media

FIG. 10 Distributor using “horizontal returning flow”

FIG. 11 Top perspective of the distributor

### DRAWINGS

### Reference Numerals

102—Feed reservoir
110—Transfer pump
120—Flow control valve
125—Sweeping flow
130—Flow control valve
140—Recirculation pump
202—EBA column
220—Media
222—Bottom mesh
301—Top mesh
302—Top support plate
303—Top outlet
304—Top waste outlet
305—Bypass plug
306—Sealing O-rings
307—Feed
308—Back flushing flow
401—Bottom support plate
402—bottom mesh
403—bottom inlet
404—Nozzle holes
405—Inner distribution core
405-1—center of inner distribution core
405-2—out ring of inner distribution core
405-3—center opening of inner distribution core
405-4—returning flow
406—Bottom outlet
407—Flow in distribution channel with gradually reduced height
408—Internal recirculation
409—Baffles
501—Bottom support plate
502—Bottom mesh
503—Retractable nozzle
503-1—retractable nozzle piece
504—Nozzle holes
505—Flow channels on bottom support plate
505-1—center edge of higher surface
505-2—outer edge of higher surface
505-3—nozzle close position
505-4—returning channel
506—Bottom outlet
507—Distribution channel
510—Higher surface sector on bottom support plate
511—Lower surface sector on bottom support plate
V101—feed recirculation tank
V102—buffer recirculation tank
V103—packing solution recirculation tank
V104—media storage tank
LXFLQ—cyclone for liquid and solid separation
T101—EBA column
B101—Feed pump
B102—packing pump
F101—pressure control valve in recirculation loop
F102—pressure control valve in top outlet
ZXCLQ—in-line filter
PIT-1—bottom inlet pressure transmitter
PIT-2—recirculation loop pressure transmitter
FIT-1—top outlet flow meter
FIT-2—bottom inlet flow meter
KQXJ—air trap
YPJ—holding tank for feed
QXYG—tank for cleaning solution
XTYG—tank for elution solution
HCYG—tank for buffer
CPG—tank for target product
Cond—conductivity meter
pH—pH meter
UV—in-line UV spectrum meter
F051—vent to waste
F052—vent to waste
F014—vent to waste
F001˜F017—open/close valves

### DETAIL DESCRIPTION OF THE PREFERRED EMBODIMENTS

The embodiments will be described in more details in combination with drawings and examples.

As shown in FIG. 1a, a sediment bed can be expanded when the liquid is flowing upwards. The dragging force and the buoyant force make the particles suspend, the bed of the suspended media is called expanded bed. It is called expanded bed adsorption (EBA) when the media is an adsorption media.

The void space/ratio in an expanded bed is far bigger than a fixed bed. Cells, debris, and solid particles in the flow can pass through expanded bed while the target molecules can be adsorpted by the functional group on the media particles.

Because the pores on the mesh are usually small, the pores may get clogged when the cells/debris/solid particles start to aggregate. In some of the cases, the mesh could be completely clogged.

On the other hand the flow distributor in traditional EBA column does not generate a sufficiently good plug flow through the bed. The total plate count in EBA is usually very low.

A typical flow pattern in a traditional EBA is illustrated in FIG. 1b. There is significant pressure difference along the mesh from the center to the circumference. This causes server back mixing at the lower part of the EBA bed (as shown by the vortex) and therefore leads to very low total plate count.

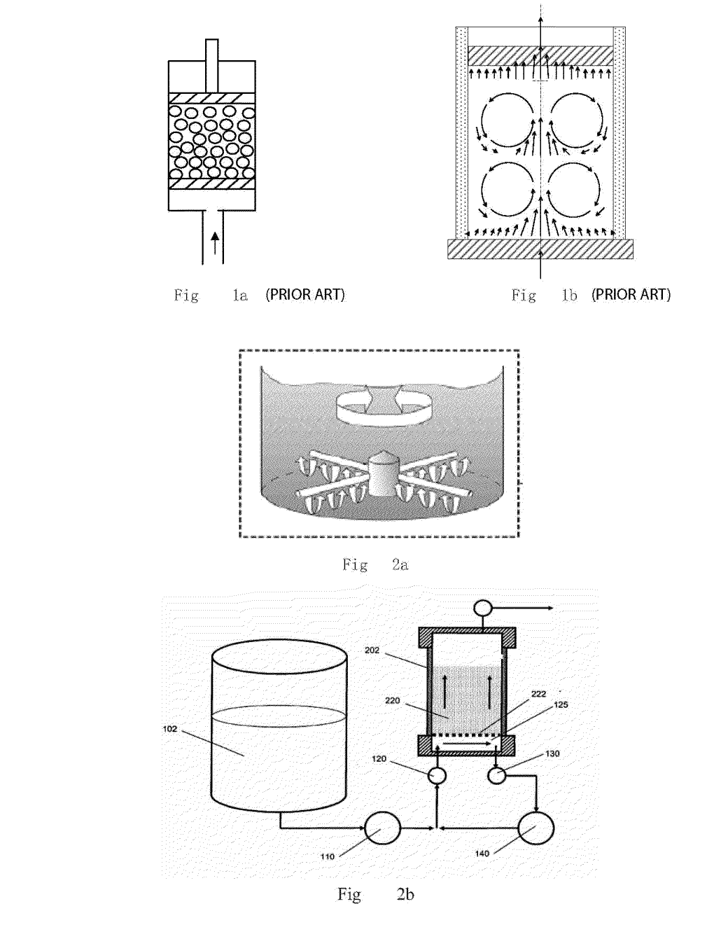

A spider design of the distributor is shown in FIG. 2a. Feeds are led into several distribution arms with perforated holes located in the bottom of the EBA column. The holes are usually pointing to the bottom and the feed flow will be injected towards the bottom of the column. The distribution arms usually oscillate periodically trying to achieve even distribution inside the column and avoid clogging.

The spider design did somehow address the issue of clogging and cleaning inside EBA columns, the setback of the design is the low total plate count in the EBA bed, particularly an issue when eluting the target molecules. A main advantage of EBA is therefore compromised.

In addition the moving parts inside the column could cause grinding of the adsorption media. Mechanical sealing around the oscillating shaft can be challenging and expansive.

A sweeping flow design is shown in FIG. 2b. The feed is delivered by pump 110 and regulated by flow control valve 120. The flow is going into the column from one side and come out of the other side. The flow sweeps through underneath the mesh 222. Part of the flow goes through the mesh into the expanded adsorption bed 220, the rest of the flow will pass through and come out from the other side (125) which will then be circulated back to the column by the recirculation pump 140 and flow control valve 130.

The drawback is again the flow distribution and total plate count. Depending on the sweeping flow rate and the holdup volume of the distributor, the pressure distribution underneath the mesh will be significantly different from the inlet to the outlet, so is the pressure distribution along the perpendicular direction. To achieve even pressure and even flow distribution, the holdup space inside the distributor needs to be large. However, the larger the holdup space is the worse the back-mixing is inside the distributor, which would significantly decrease the total plate count of the bed.

The aggregation of the particles/cells will get worse when the concentration of the feed increases. The sweeping flow gets less and less effective. The cleanability of such design is highly questionable.

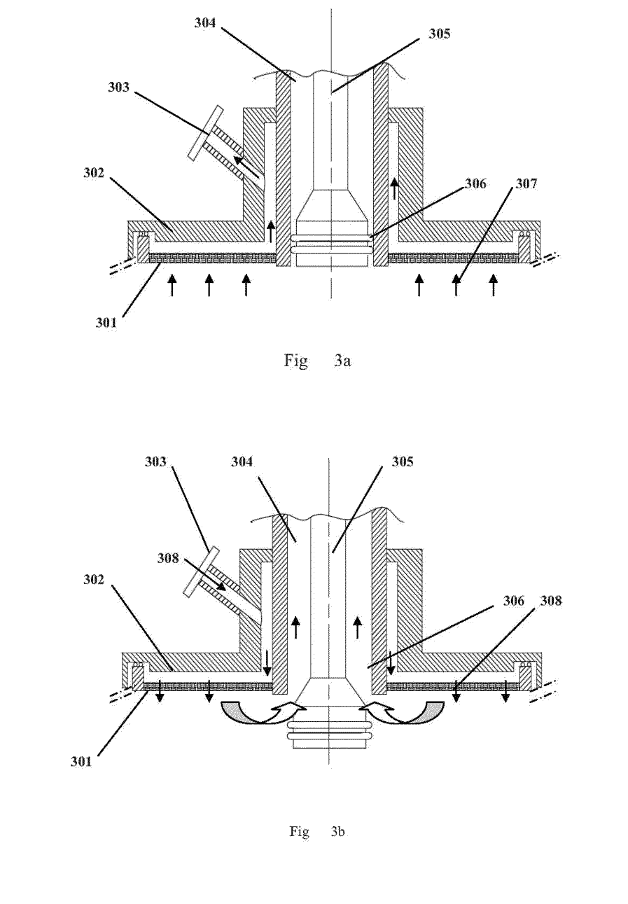

As shown in FIG. 3a, the design for the top adaptor in an EBA column in current invention is described.

A top adaptor includes a support plate 302, top outlet 303, top waste outlet 304, bypass plug 305, and sealing o-rings 306. The top adaptor will be placed at top in seal with the column tube and allows back flush of the top mesh.

Top outlet and top waste outlet are positioned above the top mesh 301 and are part of the top support plate 302. The bypass valve is cutting through the mesh and situated in the center. There is a movable plug and sealing o-rings inside the bypass valve.

The bypass valve is closed at the position shown in FIG. 3a, the column is at “normal operation” which allows the feed solution to pass through the top mesh and leave from the top outlet.

As shown in FIG. 3b, when there are fouling or clogging underneath the top mesh, the plug can be moved to the open position. The column will now allow back flush on the top net. Fresh buffer 308 comes down from the top outlet and push through the top mesh. As a result the fouling and clogging are washed away and out into the bypass valve and into waste.

When the back flush is completed the plug moves back to the close position and normal operation will be resumed.

The following paragraphs describe the approach of achieving even flow distribution using “vertical flow return”

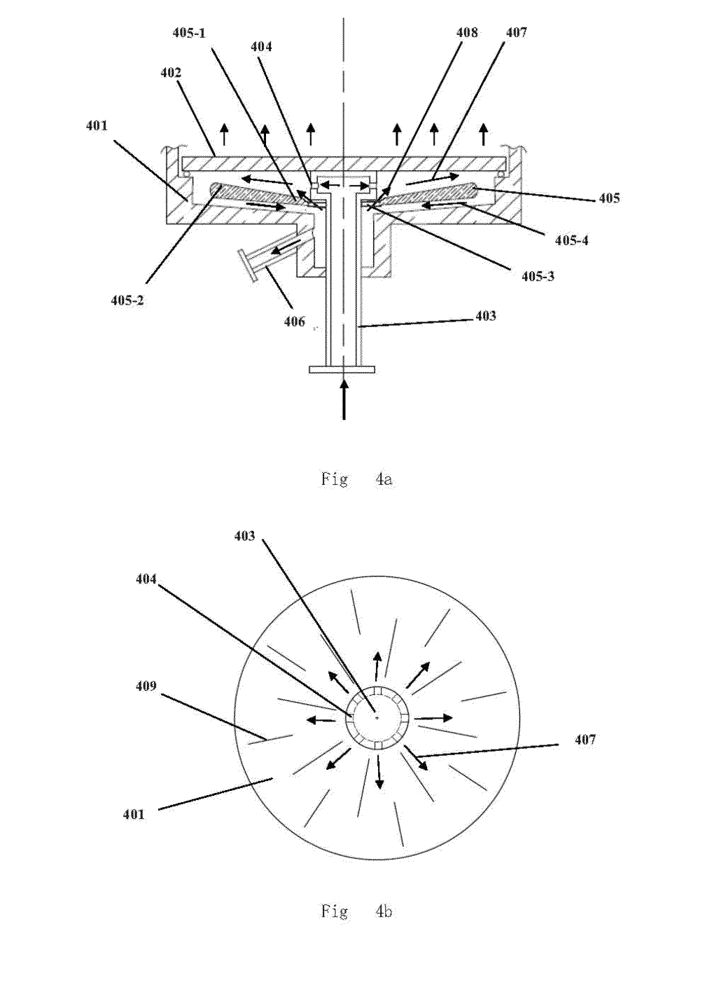

The design of the bottom adaptor is shown in FIG. 4a. It includes an injection nozzle with radial holes, placed at the center, right underneath the bottom mesh and an inner distribution core. The bottom adaptor is able to generate self-stabilized even flow distribution in the column and completely flow-cleanable.

There is a bottom inlet 403 in the center of the bottom adaptor 401. The other side of the bottom inlet is connected to the injection nozzle which is placed closely underneath the bottom mesh. The injection nozzle has a plurality of holes evenly aligned radially. An inner distribution core 405 is placed in between the top mesh and the bottom support plate. The inner distribution core has an open space 405-3 in the center which allows the injection nozzle to go through. There may be intervals intentionally left between the injection nozzle and the inner distribution core.

The inner distribution core combined with the bottom mesh above forms critical flow distribution channels 407 along the radial direction. The cross section of the channel may have a wedge-like look as the channel height is gradually reduced from the center out to the circumference.

The inner distribution core combined with the bottom support plate forms the flow returning channels 405-4.

The intervals left in between the inner distribution core and the injection nozzle help create an internal recirculation 408 from returning channels to distribution channels which will improve the flow distribution in the column.

The returning channels are connected to the bottom outlet 406 at the bottom of the bottom adaptor.

The injection nozzle is vertically placed in the center of the adaptor. The holes on the nozzle are evenly aligned along the radial direction.

The inner distribution core may have a shape of an inversed short trumpet. The height of the channel at the circumference (405-2 to 402) is usually smaller than that (405-1 to 402) at the center.

Being pushed by the pressure difference over the bottom mesh 402, the feed and its contained particles will pass through the bottom mesh into the EBA column. The target molecules in the feed are adsorpted by the media and the contaminant particles are passing and leave from the top outlet.

As the feed being injected from the holes on the injection nozzle, some of the feed will go across the bottom mesh into the column while the rest will continue to flow towards the circumference. Both the flow rate and the cross sectional area of the channels is varying and there will be undesired pressure/flow distribution along the radius. The height of the distribution channels will therefore be gradually reduced from the center out to the circumference to avoid such undesired effect.

To compensate the undesired effect, the inner distribution core and the bottom mesh are shaped to have the distribution channels with changing channel heights. The heights are gradually reducing from the center out to the circumference.

The design will generate even flow distribution across the mesh owing to the injection nozzle and the distribution channels. The flow rates inside the channel are generally high and helps self-cleaning as well. Further more the higher the flow rate the better the flow distribution along the radius becomes.

A returning flow channel is also formed (between the inner distribution core and the bottom support plate), which allows recirculation flow through the bottom adaptor.

The distribution channel formed by the bottom mesh and the inner distribution core, while working with the injection nozzle, allows cleaning of possible clogging underneath the bottom mesh or any aggregates inside the distribution channel. There will be no dead legs inside the entire distributor.

The flow will continue all the way to the circumference and comes back to the bottom outlet through the returning channels underneath the inner distribution core, formed between the inner distribution core and the bottom support plate. The flow coming out of the bottom outlet (of the bottom adaptor) will be led to a tank for recirculation back to the bottom inlet (of the bottom adaptor).

During operation the feed comes into the bottom adaptor from bottom inlet 403 and will then be injected into the distribution channel 407 through the radial holes 404 on the injection nozzle, going towards the circumference 405-2 and coming back to the bottom outlet through the returning channel 405-4. The bottom outlet will be led to a recirculation tank where it will be fed back to the bottom inlet of the bottom adaptor by the main pump.

An in-line filter may be placed in the recirculation loop from the bottom adaptor to the recirculation tank to remove possible aggregates in the feed in case it does happen. Fresh buffer can also be added to the recirculation tank to decrease the viscosity of the feed and improve the adsorption yield particularly when it is close to the end of the loading.

As shown in FIG. 4b, baffles 409 are evenly placed out in radial direction on the inner distribution core 401 to assure the flow injected from the injection nozzle is evenly distributed around 360 degree.

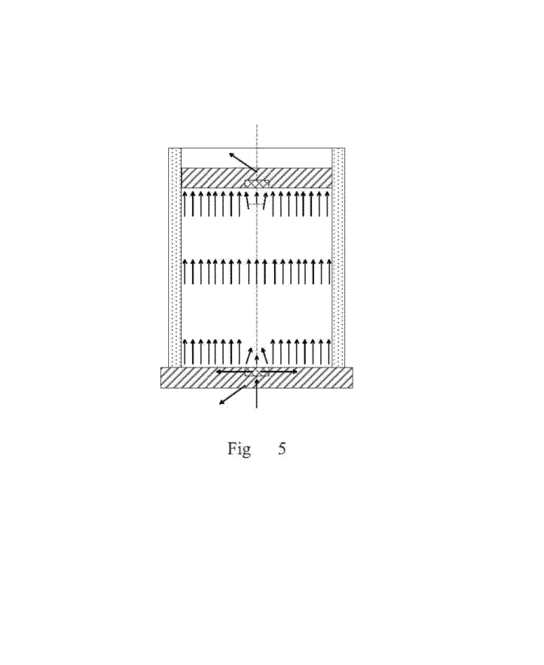

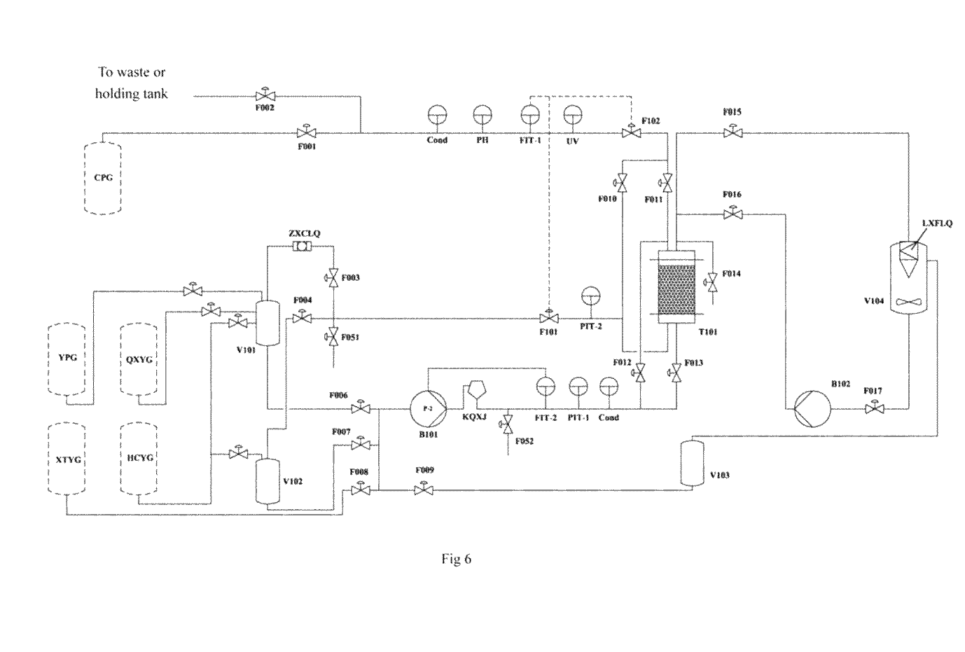

By having the bottom mesh, the inner distribution core, and the bottom support plate configured in a way shown in FIGS. 4a and 4b, the varying height of the distribution channel, in combination with an internal recirculation from the returning channel to distribution channel, leads to pressure homogenization underneath the bottom mesh, provides plug flow into the EBA bed and high total plate count. The flow velocity pattern in such EBA column is shown in FIG. 5. Significant improvement in column efficiency can be expected.

Compared with the flow velocity pattern seen in FIG. 1b, the parallel arrows in FIG. 5 illustrate the plug flow in the EBA column (independent of the flow resistance from the bed). There is very little back-mixing owing to the pressure homogenization underneath the bottom mesh. The total plate count can therefore be increased.

The injection flow rate (depending on recirculation flow rate), the channel heights of the distribution channel, and the permeability of the bottom mesh are the predominant factors that affect the pressure homogenization. Current invention is utilizing the effect from varying channel height, internal recirculation, and external recirculation to achieve even flow distribution. As a result the EBA column can provide even flow distribution in the bed with completely self-cleanable flow paths, with no flow resistance requirement from the bed, and requires very small hold-up volume inside the distributor, which means high total plate count, clogging free, high binding capacity, and sharp elution in EBA process is possible.

The particles, cells, or cell debris contained in the feed will be able to pass through the EBA bed while the target molecules are adsorpted onto the media because the media particles are suspended and the void space in EBA bed is far bigger than regular fixed beds. Such EBA bed will therefore be able to directly process particle containing feed stocks for purifying the target molecules. The traditional three steps: centrifuge, depth filtration, and capture chromatography (in fixed bed) can be replaced with one EBA step. The process can be significantly simplified. Production economy can be greatly improved from the reduced processing time, the simpler operation, and the less investment in equipment.

FIG. 6 shows how the equipment and instruments are connected in an EBA process using the column. The column comprises a top adaptor with bypass valve, a column tube, and a bottom adaptor with the specially designed self-cleanable distributor as described previously. There are a top outlet and a waste outlet on the top adaptor. There are a bottom inlet and a bottom outlet on the bottom adaptor. The top adaptor, including the top mesh, top support plate, top outlet, and waste outlet can optionally be movable along the column tube.

The process includes an EBA column T101, a recirculation tank for the equilibration buffer V102, a recirculation tank for the feed V101, a feed pump B101, media storage tank V104 with an internal cyclone LXFLQ, packing buffer recirculation tank V103, in-line filters ZXCLQ, packing pump B102, and monitoring instruments such as pressure transmitters, flow meters, conductivity meters, and UV detectors.

Buffer recirculation tank V102 and feed recirculation tank V101 are connected to the feed pump B101 through valve F007 and F006. Feed pump B101 is then connected to valve F103 and the EBA column T1011 through the bottom inlet. The top outlet (of the top adaptor of the column) connects to F011, pressure control valve F102, and to the product tank CPG through valve F001 or to waste/flow-through holding tank through (not shown in FIG. 6) valve F102.

The outlet on the bottom adaptor connects to pressure control valve F101, and back to the buffer recirculation tank through valve F004 or to the feed recirculation tank through valve F003 and in-line filter ZXCLQ to form the recirculation loop.

The top outlet and the bottom outlet are directly connected through a valve F010 for bypass purpose.

The top outlet and the bottom inlet are directly connected through a valve F012 for bypass purpose.

The top outlet connects also to valve F015, media storage tank V104, packing buffer recirculation tank V103, valve F009, and back to the feed pump B101.

Media storage tank V104 connects to valve F107, packing pump B102, valve F016, and to the waste outlet of the column T101.

The bottom outlet on the bottom adaptor connects to vent (waste) through valve F051. The bottom inlet on the bottom adaptor connects to vent through valve F052. The waste outlet on the top adaptor connects to vent through valve F014.

Other on/off valves are also placed for flow control in and out of sample tank YPG, cleaning solution tank QXYG, elution buffer tank XTYG, buffer tank HCYG, and product tank CPG.

Flow meter FIT-2, pressure transmitter PIT-1, conductivity meter COND are placed in line at the bottom inlet on the bottom adaptor. Flow meter FIT-1, conductivity meter, pH meter, and UV spectrophotometer are placed in line at the top outlet on the top adaptor. Another pressure transmitter PIT-2 is placed in the recirculation loop close to F101.

During operation feed solution will be pumped into the bottom adaptor through the bottom inlet by the feed pump. Part of the feed will come out from the top outlet after passing through the expanded bed. The rest of the feed will come out from the bottom outlet and go back to the feed recirculation tank (optionally through in-line filter).

During back-flush the buffer will be pumped into the column through the top outlet. The bypass valve is open at the same time.

The buffer will push the aggregates underneath the mesh away and wash them out into the waste outlet.

When back-flush is finished close the bypass and the operation can be resumed.

The bypass valve can be used to move the adsorption media from the storage tank V104 (LXFLQ) to the column T101 or vice versa when the feed pump B101, the packing pump B102, packing buffer recirculation tank, and media storage tank V104 work together.

Feed tank, cleaning solution tank, and buffer tank are connected to the feed recirculation tank. The respective solutions are added to the recirculation tank as needed using constant volume control.

Buffer tank is connected to the buffer recirculation tank. Fresh buffer is added to the recirculation tank as needed using constant volume control.

Elution tank is connected to the feed pump through valve F008.

A bubble trap KQXJ is placed post the feed pump and pre the column to remove the bubbles generated from the pump and the pipes.

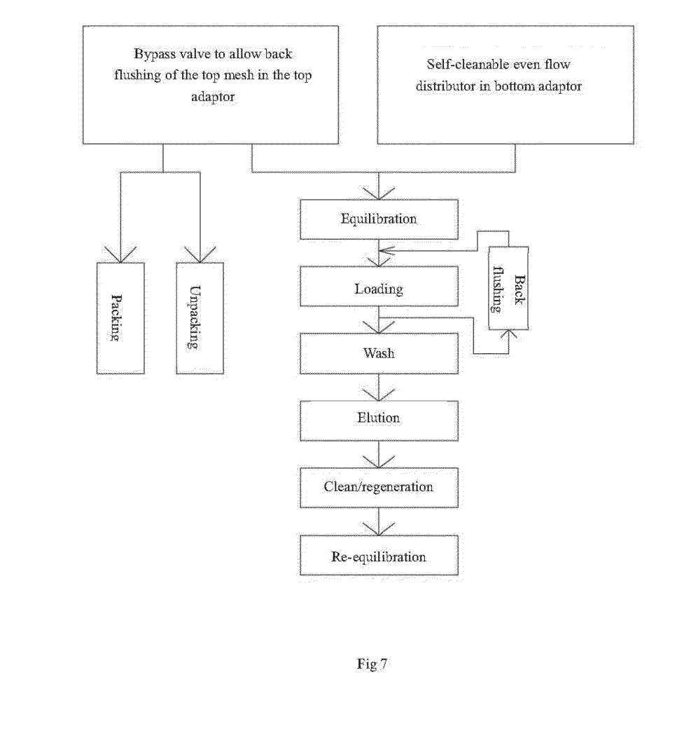

### Operation—FIGS. 7-9

As shown in FIG. 7 the process includes a top adaptor that has a bypass valve and a bottom adaptor that has a self-cleanable even flow distributor. The process involves the following six steps, occasional back flushing, and packing/unpacking of adsorption media. The process usually runs at a temperature from 4 C. to ambient.

### A. Equilibration

This is the first step in the process.

The feed pump B101 delivers the buffer from buffer recirculation tank V102 to EBA column T101 through the bottom inlet on the bottom adaptor. After some of the initial buffer being discharged to waste through valve F051, part of the buffer will go into the EBA bed and the rest of the buffer will circulate back to the buffer recirculation tank. Adjust the recirculation flow rate and the column flow rate.

Fresh buffer continues to be added to the buffer recirculation tank V102 by constant volume control. The objective of the step is to reach stable recirculation flow rate and column flow rate.

Appropriate flow rates for column flow (flow passing through the column) and recirculation flow can be reached by feedback from flow meter FIT-1 and FIT-2 and adjustment of the two pressure control valves F101 and F102 and the speed of the feed pump B101.

Column flow is an important parameter for the adsorption of target molecules in the EBA column. The recirculation flow contributes the even flow distribution in the EBA column and the cleanability of the distributor. In general the ratio of recirculation flow over column flow can range from 0 to 10 depending on the application. A carefully optimized ratio can improve the distribution and therefore the total plate count of the column.

After both flow rates and pressure are stabilized, wait for a certain amount of time or column volume of equilibration buffer that has passed through the EBA bed. Optionally instruments such as conductivity meter can also be used to determine when the equilibration is completed.

### B. Loading

The inlet of the feed pump B101 will first be switched to the feed recirculation tank V101. The bottom outlet on the bottom adaptor will also be switched to the feed recirculation tank V101. The recirculation flow may be briefly diverted to the waste/vent to discharge the residual buffer.

Adjust both the column flow rate and the recirculation flow back to the target as necessary. The flow rates can be fedback by FIT-1 and FIT-2 and adjusted by the pressure control valve F101/F102 and the speed of the feed pump.

The feed solution is pumped by B101 from feed recirculation tank V101 to EBA column T101 bottom inlet. Part of the feed circulates back to feed recirculation tank V101 through the bottom outlet in the bottom adaptor. The rest is passing through the EBA bed at the column flow rate while the target molecules in the flow are being adorpted to the media particles in the column.

The column flow will continue to go out of the column from the top outlet, through the monitoring instruments, UV, conductivity meter, pressure transmitter, flow meter, and finally to the flow-through holding tank or waste.

Fresh feed is added to the feed recirculation tank by controlling the constant volume of the feed recirculation tank.

A back flush on the top mesh may be performed as needed, when aggregation happens on the top mesh or when pressure drop increases. To run the back flush, stop the feed pump B101 and open the bypass valve on the top adaptor. The inlet of the feed pump is switched to the buffer recirculation tank V102 (constant volume control). After pumping some initial portion of the buffer to waste, the feed pump delivers the buffer through the column bypass line F012 into the top outlet of the top adaptor. At the same time open the bypass valve on the top adaptor. The buffer will come in from the top outlet and flush the aggregates or clogging underneath the top mesh away and wash them into the bypass valve and to waste.

After the back flush is completed, stop the pump B101 and close the bypass valve on the top mesh and valve F010. Switch the inlet of the feed pump to feed recirculation tank and outlet of the pump to the bottom inlet on the bottom adaptor, close valve F012, and resume the feed loading. The back flush can be applied as many times as needed to assure nothing is clogging the top mesh until the feed loading is completed.

An air sensor may be placed in line to signal the end of the loading phase.

Fresh buffer may be added to the feed recirculation tank V101 after all feed has been applied to improve the yield.

### C. Washing

Switch the inlet of the feed pump B101 to the buffer recirculation tank V102 and the bottom outlet on the bottom adaptor to the buffer recirculation tank V102.

Adjust the recirculation flow and column flow as needed. Wait until a certain amount of buffer has passed through or the monitoring instrument such as conductivity, pH, or UV reaches pre-determined criteria.

### D. Elution

Stop the feed pump B101 and let the bed settle. While keeping the top outlet open to waste, lower the top adaptor until it is close enough to the sediment surface of the bed. Lock the adaptor at the position.

Start the feed pump B101 with the pump inlet connected to buffer recirculation tank V102. Close the bottom outlet (on the bottom adaptor). Adjust the column flow as needed by using flow meter FIT-1 and pressure control valve F102.

Wait for a certain amount of column volume of buffer passing through or until the monitoring instrument such as conductivity, pH, or UV reaches pre-determined criteria.

To start the elution, the inlet of the feed pump is switched to elution buffer tank XTYG. Keep the bottom outlet closed. Adjust the pressure control valve F102 so that the column flow is on target (feedback of FIT-1) as the process requires.

Keep monitoring UV, pH, and conductivity, switch the top outlet to product tank CPG when product peak is detected. Switch the top outlet back to flow-through holding tank or waste after the peak has passed.

### E. Cleaning/Regeneration

After the elution is done stop the feed pump B101 and open the bypass and the top vent F104 on the top adaptor.

Raise the top adaptor back to its original position, close the bypass valve and lock the position.

Empty the feed recirculation tank V101 and replace it with the cleaning solution from the tank of cleaning solution QXYG. Start the feed pump B101 with the inlet of the pump connected to the feed recirculation tank V101 and the bottom outlet on the bottom adaptor connected to the feed recirculation tank V101 as well (Valve F?10 open).

Adjust the recirculation flow and column flow as the process requires. Wait for a certain amount of column volume of cleaning solution passing through or until the monitoring instrument such as conductivity, pH, or UV reaches pre-determined criteria.

### F. Re-Equilibration

After cleaning is finished, stop the feed pump B101.

Replace the solutions in the feed recirculation tank V101 with the equilibration buffer.

Start to run the feed pump B101 with both the inlet of the pump and the bottom outlet on the bottom adaptor connected to the feed recirculation tank V101. The bottom outlet on the bottom adaptor can be briefly diverted to waste.

Adjust the recirculation flow and column flow as the process requires. Wait for a certain amount of column volume of equilibration buffer passing through or until the monitoring instrument such as conductivity, pH, or UV reaches pre-determined criteria.

At the end of regeneration the system is ready for the next cycle. You can stop the feed pump B101 and empty the two recirculation tanks V101 and V102 if the system needs to shut down.

### G. Packing

Additionally packing and unpacking of the media into the column can be performed using the same equipment.

Fill the EBA column T101 with packing buffer. Open the bypass valve on the top adaptor.

Start the packing pump B102 to deliver the media slurry V104 into the EBA column T101 through the bypass valve while keeping the top outlet open.

The media particles will settle down inside the column and the packing buffer will overflow from the top mesh on the top adaptor out to waste. EBA column be packed in place thereby.

### H. Unpacking

To unpack the column, close the top outlet on the top adaptor, and open the bypass valve on the top adaptor. Switch the inlet of the feed pump to packing buffer tank V103.

Start the feed pump B101 and increase the flow rate until the superficial velocity inside the column exceeds the terminal velocity of the media particles. The media particles will therefore be brought out through the bypass valve back into media storage tank V104.

The cyclone LXFLQ inside the media storage tank V104 will keep the media particles inside the tank but allow the packing buffer to overflow back to the packing buffer tank V103.

Keep running the feed pump at the flow rate until all media particles move back to the slurry tank.

More specifically fresh buffer can be added to feed recirculation tank to reduce the viscosity and particle concentration and possibly improve the process yield after the feed solution has all been processed.

More specifically the ratio of recirculation flow to column flow can vary from 0 to 10 depending on specific process with regards to flow distribution and cleanability.

When a retractable nozzle is alternatively used the nozzle moves up to open all the holes to the distribution channels (between the bottom mesh and the inner distribution core) during most of the operation except elution.

During elution of the process, the nozzle will be retracted to its closing position to avoid any possible dead space in the distribution channels and the returning channels (elution flow going downward).

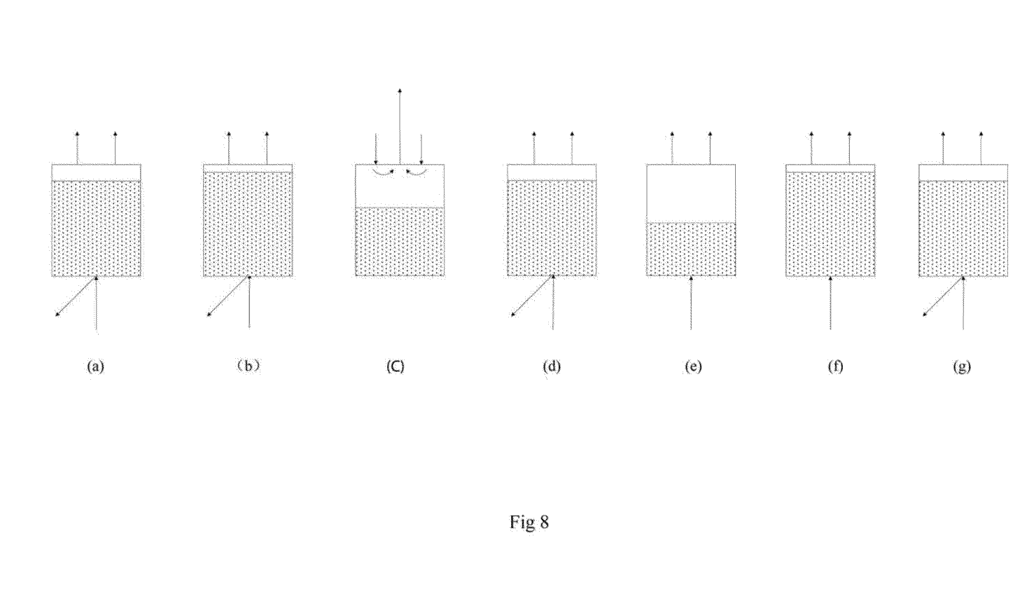

As illustrated in FIG. 8, the EBA column has different status at different stage of the process:

Part (a) represents “equilibration”: buffer comes into the column from the bottom inlet and out of the top outlet; recirculation flow comes out from the bottom outlet, which could have important impact on the flow distribution and distributor cleanability

Part (b) represents “loading”: a back-flush is needed as column pressure drop increases significantly

A back-flush, as shown in part (c), is being performed to wash out the aggregates formed underneath the top mesh

Part (d) represents “washing”.

Part (e) represents “elution”.

Part (f) represents “cleaning/regeneration”.

Part (g) represents “re-equilibration”.

In part (e) the bed is smaller as the EBA bed settles into a fixed bed and the top adaptor is lowered.

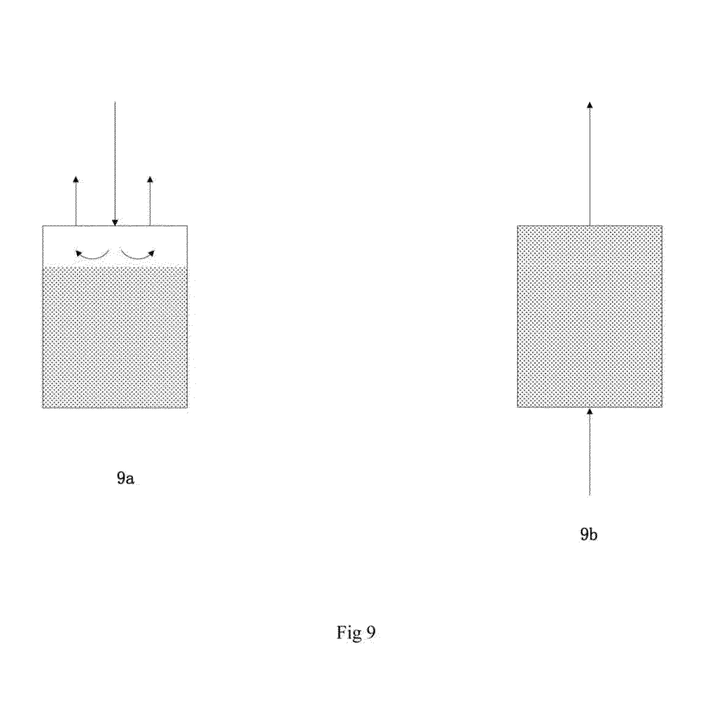

FIG. 9a represents “packing in place”. The column is first filled with packing buffer. Open the bypass valve on the top adaptor. Pump the media slurry from the storage tank to the EBA column through the bypass valve.

The media particles settle inside the column but the packing buffer overflows through the top mesh.

FIG. 9b represents “unpacking in place”. When the flow superficial velocity in the column exceeds the terminal velocity of the media particles, the media particles will be brought out of the column through the bypass valve on the top adaptor, and finally into the media storage tank. The media particles will be retained in the tank by the built-in cyclone and the packing buffer will overflow back to the packing buffer recirculation tank.

Keep running the feed pump at the flow rate until all media particles move back to the slurry tank.

Media packing into the column and removal from the column can therefore be done without opening the adaptor of the column. This is called “packing in place” and “unpacking in place”.

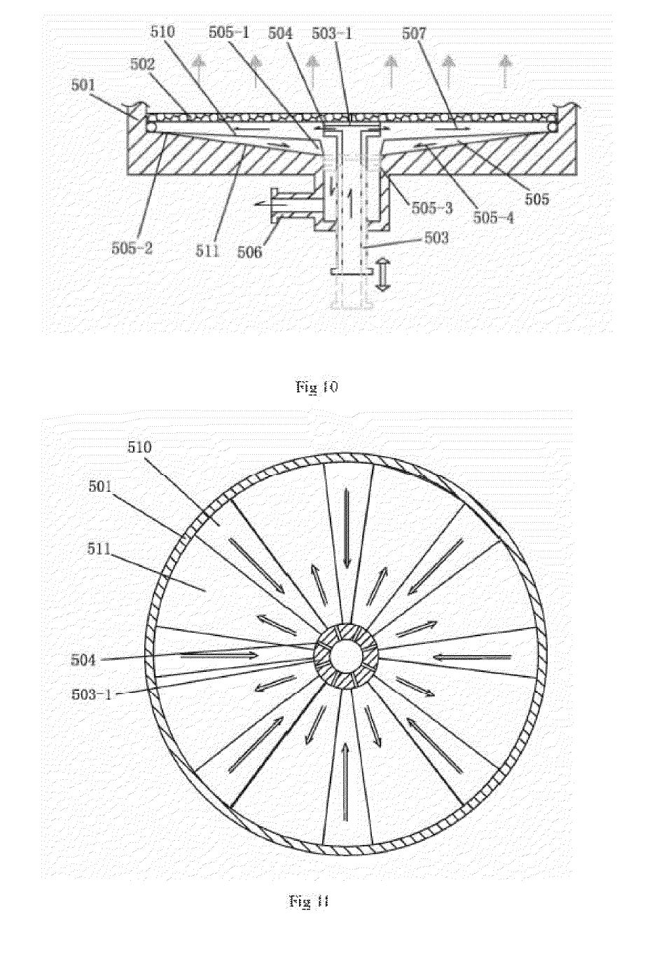

The structure of the distributor using “horizontal returning flow” and the flow paths inside it are shown in FIG. 10. It comprises the bottom support plate 501 with radial flow channels 505, the bottom mesh 502, and the injection nozzle 503 in the center. There are holes 504 aligned in radial direction at the top of the nozzle. The distribution channels are formed between the bottom mesh and the bottom support plate going from the center to the circumference.

The radial flow channels 505 are alternated with a series of high surface sectors 510 and low surfaces sectors 511, evenly aligned on the circle. The space between the mesh and the high surfaces sector and low surfaces sectors are the flow channels.

The nozzle is placed in the center of the circle. The high surface sectors and low surface sectors are evenly alternated around the circle.

The total number of the nozzle holes 504 at the top of the nozzle is the same as that of the high surface sectors.

The total number of the holes 504 on the nozzle piece is the same as that of the high surface sectors.

The holes on the nozzle are pointing to the high surface sectors respectively.

In one of the specific design, as shown in the same figure, the height of the distribution channel, which is the distance between the mesh and the high surface sectors, gradually decreases from the center 505-1 to the circumference 505-2.

Meanwhile the height of the returning channel, which is the distance between the mesh and the low surface sectors, gradually increases from the circumference 505-2 to the center 505-1.

The cross sectional area of the distribution channels may gradually decrease as the flow going from the center to the circumference.

The cross sectional area of the returning channels may gradually increase as the flow going form the circumference to the center.

One way to simply the design and fabrication is to make the high surface sectors and the low surface sectors 505 part of the bottom support plate 501 as shown in the same figure.

Specifically the distribution channels are formed between the mesh and the high surface sectors.

The returning channels are formed between the mesh and the low surface sectors.

Further the cross sectional area of the distribution channels from the center to the circumference gradually decreases and that of the returning channels from the circumference to the center gradually increases to assist the flow 507 and 505-4 in the desired direction.

To further improve the cleanability, the height of the distribution channels, which is the distance between the mesh and the high surface sectors, can gradually increase from the center 505-1 to the circumference 505-2. Meanwhile the height of the returning channels, which is the distance between the mesh and the low surface sectors, increases from the circumference 505-2 to the center 505-1.

In one of the specific design of the type, the height of the distribution channel, which is the distance between the mesh and the high surface sectors, remain unchanged from the center 505-1 to the circumference 505-2 and the height of the returning channel, which is the distance between the mesh and the low surface sectors, gradually increases from the circumference 505-2 to the center 505-1.

As shown in FIG. 10 the difference between the distribution channel heights from the center to the circumference will be less than that between the returning channel heights from the circumference to the center.

When the nozzle is at open position, the nozzle piece is raised up to the solid line as shown in the figure. The nozzle allows the flow to inject itself through the radial holes over (507) to the high surface sectors 510. The flow continues to the circumference 505-2 and go down (505-4) to the low surface sectors 511, to the outlet 506.

A top down perspective of the “horizontal returning flow” is shown in FIG. 11. The high surface sectors 510 and the low surface sectors 511 are alternated on the circle.

They are evenly aligned in the radial directions.

The holes 504 on the nozzle piece 503-1 are aligned with the high surface sectors respectively.

The total area (or angle) of the high surface sectors is larger than that of the low surface sectors.

The design of the “horizontal returning flow” is relatively simple and easy to fabricate and can be the preferred design for small scale and low throughput applications.

The distributor can be completely hygienic and dead leg free, particularly when a retractable nozzle piece is included.

### EXAMPLES

### Example 1

### Purifying Monoclonal Antibody (MAb)

The target MAb was expressed in CHO cells and secreted in cell culture media. The CHO cell has a size of 10-15 um. The cells were growing in bioreactors ranging from 1,500 L to 10,000 L. The final cell density was 1×10⁷ cells/ml. titer 0.5 g/L.

The traditional three step process requires high capacity centrifugation, depth filtration, and protein A chromatography. A second and third chromatography steps and a UF/DF will be needed for further downstream processing. The process of the traditional three steps could last three days.

The protein A chromatography was running at a linear velocity of 180 cm/hr, bed height 30 cm, retention time 10 min, and binding capacity at 20 g/L.

The column volume was 37.5 L and has a diameter of 40 cm. The column flow rate was 225 L/hr. Feed volume is 1,500 L and needed to be loaded on to the column in 6.6 hr.

The high capacity centrifuge is expensive. Depth filtration involves lot consumables. Protein A chromatography in fixed bed has relatively low throughput and takes long time to load. The yield from the three steps is usually 95%, 90%, and 97%. The overall yield from the three steps is 82%.

An EBA process will replace the three traditional steps with one protein A expanded bed chromatography.

Adsorption media: streamline r-protein A
Media particle size: ˜150 um/80-165
Density: 1.3 g/ml
Mesh pore size: 20 um
Sediment bed height: 30 cm
Linear velocity: 240 cm/hr (200-400 cm/hr)
Binding capacity: 17.5 g/L
Column volume: 42 L
Column diameter: 50 cm (˜43 cm)
Ratio of recirculation flow to column flow: 2.5
Column flow: 471 L/hr

### Pressure: <1.0 bar

Loading time: 3.2 hr

### Yield: >92%

Compared to the traditional three steps, the process using EBA is much simpler and reduces the processing time significantly by 60%. This is particularly important to MAb purification. In the meantime, the initial capex spending in equipment would be 40% less. The direct material cost can be reduced by 25%. The overall yield (before further downstream) increases by 10%.

### Example 2

### Purifying Recombinant Human Serum Albumin (rHSA)

rHSA was expressed in Pichia Pastoris and secreted from the cells. The cells were growing in a 5,000 L fermenter. The final titer is ˜1.0 g/L.

The traditional process would require centrifugation and depth filtration before the first chromatography step, usually an ion exchange step in this case. A hydrophobic interaction chromatography and another ion exchange chromatography are needed for further downstream purification. The first three steps up to the first chromatography usually take 3 days.

The linear velocity is 120 cm/hr (120-180 cm/hr) for the capture chromatography. The bed height is 30 cm. The retention time is 15 min. The binding capacity is about 10 g/L. The column volume is 500 L. The column diameter is 140 cm (145 cm). The column flow rate is 1900 L/hr. The volume of the feed is 5,000 L. Loading needs to finish within 2.6 hr. The yield for the three steps: centrifugation, depth filtration, and first ion exchange are 90%, 90% and 95%. The overall yield up to the first chromatography is 76%.

An EBA process will replace the three traditional steps with one ion exchange step in expanded bed chromatography.

Adsorption media: streamline SP (GE healthcare)
Media particle size: ˜200 um/100-300 um
Density: 1.2 g/ml
Mesh pore size: 20 um
Sediment bed height: 30 cm
Linear velocity: 250 cm/hr 2×(200-400 cm/hr)
Binding capacity: 8.5 g/L
Column volume: 588 L
Column diameter: 160 cm (˜158 cm)
Ratio of recirculation flow to column flow: 3.0
Column flow: 5000 L/hr
System flow: 15000 L/hr

### Pressure: <1.0 bar

Loading time: 1.0 hr

### Yield: >90%

Compared to the traditional three steps, the process using EBA is much simpler and reduces the processing time significantly by 60%. In the meantime, the initial capex spending in equipment would be 40% less. The direct material cost can be reduced by 25%. The overall yield (before further downstream) increases by 30%.

### Example 3

### Purifying Antibiotics from Cell Lyses

Antibiotics manufacturing is another industrial area where EBA can be widely useful.

Chromatography purification is now required by more and more antibiotics processes as higher and higher purity of the drug is demanded by the regulatory body. Some of the processes in antibiotics manufacturing are notorious for forming aggregation and most of them need to run at very high throughput. These would make EBA the best candidate.

### Example 4

### Purifying Lactoferrin from Milk

The process can be particularly suitable for treating milk for value added product such as Lactoferrin because of its capability of processing particulate containing feed stock. The fact that one EBA step can replace the three steps: centrifugation, depth filtration, and capture chromatography will significantly simplify the process and improve the process economy.

In summary the invention can be particularly important to: Monoclonal antibody production (high dosage, in tons/year), recombinant human serum albumin (>500 tons/year globally, commonly >10 tons/year), and transgenic drugs expressed in milk (high viscosity and a lot of contaminant proteins).

By implementing a self-cleanable even flow distributor in the bottom adaptor and a back-flush capable top bypass valve in the top adaptor, the EBA column is capable of processing particle containing feed stock directly without being clogged on the mesh, which was the challenge for previous EBA applications.

The flow channel sizes and the mesh pore size are determined as part of the equipment parameters but recirculation flow and column flow are part of operation parameters of the process. These additional operation parameters make the process easy to control and well fitted to industrial operation. The distributor so designed can achieve even flow distribution with very small holdup volume (in comparison with the bed volume) in the distributor, little back-mixing, very low flow resistance from the bed, and is completely flow-cleanable. These features make it possible to run EBA for processing particle containing feed, at sufficiently high total plate count and low bed expansion, and therefore achieve the core benefit of the original EBA concept

EBA columns so designed can find wide applications in purifying target proteins directly from most of the microbial or cell culture based feed stocks.

The innovation includes:

1. a new design for EBA columns, which allows direct processing of cell/cell debris containing feed stocks for target molecules at high throughput and high total plate count; which simplifies the traditional separation process significantly and is of great importance to large scale biological production such as monoclonal antibodies and recombinant human serum albumin;

2. an even flow distributor placed underneath the bottom mesh in the bottom adaptor, which has very low holdup volume, is self-cleanable, requires no flow resistance from the bed to generate even flow;

3. a back flush bypass valve in the top adaptor, which allows a back flush wash from above the mesh to push away the aggregates and clogging possibly formed underneath the top mesh;

4. in-line filters in the recirculation loop, which allows removal of large aggregates in the recirculation loop;

5. built-in cyclone inside the media storage tank combined the EBA column, which allows packing and unpacking in place of the EBA media and reuse of the packing buffer;

6. direct processing of cell/debris containing feedstock, which combines centrifugation and filtration with the capture chromatography in one step; which significantly reduces the capital spending;

7. complete cleaning-in-place and packing/unpacking in place, which allows easier automation;

8. “vertical flow return” and “horizontal flow return”, which can be selectively applied for small scale and large scale applications; and

9. a retractable nozzle piece, which allows true hygienic design of the EBA column for large scale production.

### INDUSTRIAL APPLICABILITY

The invention has provided an expanded bed chromatographic adsorption (EBA) column for a biochemical separation process and a technical process thereof. By providing a pressure equalization liquid distributor having a self-cleaning function below a porous blocking sieve plate at the bottom of the expanded bed, and providing an upper part nozzle assembly having a backflush cleaning function at the top of the expanded bed, the expanded bed chromatographic adsorption column is suitable for treating a feedstock liquor having solid particulate impurities, and at the same time a better distribution of the feedstock liquor added into the expanded bed can be achieved, ensuring that the fluid passed through the expanded bed layer displays a state of piston flow. The expanded bed layer displays a state of piston flow. The expanded bed chromatographic separation column and the technical process thereof have the following advantages: they greatly increase the separation theoretical value and the chromatographic separation efficiency of the expanded bed; improve the utilization result effect and efficiency of the expanded bed; and increase the adsorption load and the desorption resolution of the expanded bed.

The technical solution of the invention is especially suitable to treat directly cell lysis solution having solid, achieving a high-flux and high number of theoretical plate chromatographic separation without processing steps of centrifugation and filtration. It has simplified technological process of production in biochemical separation. It is significant especially in the production of monoclonal antibodies and recombination albumin, etc, in large-scale.

1. A column for expanded bed adsorption (EBA) chromatography for biopharmaceutical purification and bioprocessing, comprising a first mesh and an outlet on the top adaptor, and a second mesh and an inlet on the bottom adaptor, characterized by:
the top adaptor includes a bypass valve that allows back flush of the mesh, a feed outlet, a waste outlet, a movable plug, and sealing o-rings;
the bottom adaptor includes a self cleanable even flow distributor, which is comprised of a feed inlet, radial injection holes, a distribution inner core, and a feed outlet;
when aggregation or clogging is happening underneath the top mesh and flow resistance increases, a back flush flow can be applied from above the top mesh through the feed outlet to push the aggregates or clogging away from the mesh, in the meantime the plug is moved down and opens the bypass valve, which allows the aggregates or clogging to be pushed out to the waste, after the back flush, the plug moves up and closes the bypass valve and the normal operation resumes;
said distribution inner core and the first mesh on the bottom adaptor form the flow distribution channels from the center out along the radial directions;
the feed is injected into the distribution channels in the radial directions by the nozzle, sweeping underneath the mesh and push possible aggregates back to the bulk flow, and goes back to the feed recirculation tank through the outlet, the flow path including the mesh can therefore be self-cleanable by flow itself; and
by implementing the top adaptor with a bypass for back flush and a self cleanable even flow distributor such EBA columns are well fitted to directly process particulate containing feed stocks with improved efficiency and performance in large scale production in biopharmaceutical and bioprocessing industries.

2. The column of claim 1, wherein the top adaptor has a feed outlet and a waste outlet above the mesh, the waste outlet cut through the mesh and end with a movable plug and sealing o-rings which serves as a bypass valve (through the mesh);
when the plug is at its upper position the bypass valve is closed by the plug and the sealing o-rings and the column works as a normal chromatography column, feed passing through the top mesh and go out through the feed outlet; when the plug is at its lower position the bypass valve is opened and a back flush can be applied, fresh buffer pushing down from above the mesh through feed outlet and aggregates or clogging being pushed away the mesh and out to the waste through the waste outlet, after the back flush, the plug moves up and closes the bypass, the chromatography normal operation resumes;
by moving up and down the plug the bypass valve can be closed or opened, which can also be used to move the adsorption media in and out of the column (pack in place and unpack in place).

3. The column of claim 1, wherein the bottom outlet on the bottom adaptor is connected to the bottom adaptor (on the wall or at the bottom).

4. The column of claim 1, wherein an injection nozzle is placed in the center right underneath the bottom mesh and connected to the bottom (feed) inlet.

5. The column of claim 1, wherein an injection nozzle is placed in the center right underneath the bottom mesh and connected to the bottom (feed) inlet and the nozzle is retractable; the nozzle has radial holes evenly aligned along the radial directions.

6. The column of claim 1, wherein an inner distribution core is placed between the bottom mesh and the bottom support plate to form flow distribution channels evenly aligned in radial directions; there is an opening in the center of the distribution core to allow the injection nozzle to connect to the feed inlet.

7. The column of claim 6, wherein the height of the flow distribution channels in radial directions remain unchanged from the center out towards the circumference.

8. (canceled)

9. (canceled)

10. The column of claim 6, wherein the inner distribution core has baffles evenly aligned along the radial directions; the inner distribution core and the bottom support plate form the flow returning channels; the opening in the center of the distribution core may be equal to or bigger than the outside of the injection nozzle, which may allow an internal recirculation between the distribution channels and the returning channels.

11. (canceled)

12. The column of claim 6, wherein the distance between the high surface and the mesh forms the flow distribution channels and gradually decreases from the center out along the radial directions;
the distance between the low surface and the mesh forms the flow returning channels and increases from the circumference to the center along the radius.

13. The column of claim 6, wherein the distance between the high surface and the mesh forms the flow distribution channels and gradually increases from the center out along the radial directions.
The distance between the low surface and the mesh forms the flow returning channels and decreases from the circumference to the center along the radius.

14. The column of claim 6,
wherein the distance between the high surface and the mesh forms the flow distribution channels and remains unchanged from the center out along the radial directions.
The distance between the low surface and the mesh forms the flow returning channels and remains unchanged from the circumference to the center along the radius.

15. The column of claim 6, wherein the distribution core is part of the bottom support plate (horizontal flow return).

16. The column of claim 1, wherein the injection nozzle has a retractable piece;
when the nozzle piece is at its upper position the holes are open and the feed can be sweeping into the radial distribution channels in between the mesh and the distribution core;
during elution phase, the nozzle may be lowered to its lower position to close the holes and temporally disconnect the nozzle from the distribution channels.

17. The column of claim 6, wherein the top adaptor has a feed outlet and a waste outlet, the bottom adaptor has a feed inlet and a feed outlet; the mesh, the support plate, the feed outlet, and the waste outlet constitutes the top adaptor, which can be movable along the column tube, characterized by:
the EBA chromatography process includes an EBA column, a recirculation tank for the equilibration buffer, a recirculation tank for the feed, a main pump, media storage tank with internal cyclone, packing buffer recirculation tank, in-line filters, and packing pump;
the buffer recirculation tank and feed recirculation tank connect to the feed pump inlet. The pump outlet is connected to the bottom inlet (on the bottom adaptor) of the EBA column, the top outlet (on the top adaptor) of the EBA column is connected to a pressure control valve which is then connected to the product tank or a flow-through holding tank;
the bottom outlet (on the bottom adaptor) of the column is connected to a pressure control valve which is connected to the feed recirculation tank, in-line filter may be optionally placed in between the pressure control valve and the recirculation tank;
the bottom outlet (on the bottom adaptor) of the column is connected to the pressure control valve which is connected back to the buffer recirculation tank;
the bottom outlet (on the bottom adaptor) is connected to the top outlet (on the top adaptor) through a valve to form a bypass line;
the top outlet (on the top adaptor) is connected to the outlet of the feed pump through a valve;
the top waste outlet (on the top adaptor) is vented to waste, the top waste outlet (on the top adaptor) is also connected through a valve to the media tank, the overflow outlet of the media tank is connected to the packing buffer tank which is connected to the inlet of the feed pump;
the inlet of the packing pump is connected to the bottom outlet of the media tank. The outlet of the packing pump is connected to the top waste outlet (on the top adaptor);
the bottom outlet (on the bottom adaptor) has a vent to waste through a valve;
the bottom inlet (on the bottom adaptor) has a vent to waste through a valve;
the top waste outlet (on the top adaptor) has a vent to waste through a valve as well;
valves are placed at the bottom inlet and outlet (on the bottom adaptor) and top outlet (on the top adaptor), the inlets and outlets of the buffer recirculation tank, the feed recirculation tank, and the media tank;
a flow meter, a pressure transmitter, and conductivity meter are placed in line at the bottom inlet, another flow meter, another conductivity meter, pH meter, and UV detector are placed in line at the top outlet, pressure transmitters are also placed in line in buffer recirculation loop and feed recirculation loop;
during operation the feed pump takes the feed from the feed recirculation tank and feed it into the bottom adaptor; part of the feed is passing through the EBA bed where the active target is being adsorbed and the particles and non-active molecules are flowing through, the rest of the feed recirculates back to the feed recirculation tank through the bottom outlet (on the bottom adaptor) when the recirculation is on;
when there are clogging underneath the top mesh a flush can be applied by opening the bypass valve (plug moving up) on the top adaptor and a buffer flow can be pumped through the bypass line to the top outlet (on the top adaptor), the flow will come down from the top and flush out the aggregates/clogging underneath the top mesh into the opened bypass valve and into the waste;
the normal operations for EBA chromatography can be resumed by closing the bypass valve (plug moving down) and restoring the original flow paths when the back flush is done;
the top waste outlet (on the top adaptor) combined with the packing buffer tank, media tank, feed pump, and packing pump can also be used for packing media into the EBA column or unpacking the media out to the media tank, i.e. to move the media from the media tank to the EBA column or vice versa.

18. The column of claim 17, wherein feed, equilibration buffer, and cleaning solution can be continuously added to the feed recirculation tank by controlling constant volume in the feed recirculation tank;
fresh buffer can be continuously added from the buffer tank to the buffer recirculation tank by controlling constant volume in the buffer recirculation tank;
the inlet of feed pump is connected to the elution buffer tank;
a bubble trap may be placed in-line before the inlet of the bottom adaptor.

19. (canceled)

20. (canceled)

21. (canceled)

22. (canceled)

23. (canceled)

24. An injection nozzle inside the bottom adaptor of an EBA column, comprising:
a) a nozzle with a plurality of holes that are sufficiently small and evenly aligned in the radial directions from the center pointing to the circumference;
b) said nozzle positioned in the center of the bottom adaptor;
c) said nozzle placed sufficiently close and underneath the bottom mesh;
d) said holes leveled in the direction parallel to the surface of said bed support mesh; and
e) the other side of the nozzle connected to the bottom inlet of the bottom adaptor.

25. The injection nozzle of claim 24, said injection nozzle is retractable so that said holes can be open or closed with the nozzle movement.
